(19) United States
(12) Patent Application Publication
(10) Pub. No.: US 2022/0114959 A1
(43) Pub. Date: Apr. 14, 2022

(54) DRIVING CIRCUIT FOR DISPLAY PANEL

(71) Applicant: SITRONIX TECHNOLOGY CORP., Jhubei City (TW)

(72) Inventors: CHIA-CHIH CHUNG, JHUBEI CITY (TW); HUAI-YI HSU, JHUBEI CITY (TW); SHU-TSENG CHEN, JHUBEI CITY (TW); CHIH-HSUN WENG, JHUBEI CITY (TW); I-HSIU YU, JHUBEI CITY (TW); KUO-HAO LI, JHUBEI CITY (TW)

(21) Appl. No.: 17/328,233

(22) Filed: May 24, 2021

Related U.S. Application Data
(60) Provisional application No. 63/029,550, filed on May 24, 2020.

(51) Int. Cl. G09G 3/3233; G09G 3/3258

(52) U.S. Cl. CPC G09G 3/3233; G09G 2320/0247; G09G 3/3258

(57) ABSTRACT

The present application relates to a driving circuit for display panel, which drives a plurality of pixel structures of a display panel. Each of pixel structures comprises a light emitting element, which is coupled between a first voltage and a second voltage. The driving circuit comprises a power supply circuit, which is coupled to the pixel structures, provides the first voltage and the second voltage, and adjusts the first voltage or/and the second voltage for adjusting a voltage difference between the first voltage and the second voltage. That is, a current flowing through the light emitting elements of the pixel structures may be adjusted for reducing the flicker in the display panel.

### FIELD OF THE INVENTION

The present application relates generally to a driving circuit, and particularly to a driving circuit for a display panel, which may reduce the flicker.

### BACKGROUND OF THE INVENTION

A display panel is one of indispensable components for electronic devices with displaying functions and used for displaying images. The mainstream displays include liquid-crystal display (LCD) panels and organic light-emitting diode (OLED) display panels. An OLED display panel comprises a plurality of pixel structures, in which each of the pixel structures includes a light-emitting element. A driving circuit drives the light-emitting elements of the pixel structures of the OLED display panel to emit light for displaying images. Unfortunately, the flicker phenomenon is occurred in OLDE display panel while displaying images, especially when the frame rate of the OLDE display panel is the low frame rate. In other words, the flicker will be obvious while the frame is refreshed for a longer period.

Accordingly, the present application provides a driving circuit for the display panel, which may adjust currents flowing through the light-emitting elements of the pixel structures for reducing the flicker in the display panels.

### SUMMARY

An objective of the present application is to provide a driving circuit for display panel, which provides a first voltage and a second voltage to a plurality of light-emitting elements of a plurality of pixel structures. A voltage difference between the first voltage and the second voltage is adjusted by adjusting the first voltage or/and the second voltage. Hence, a current for driving the light-emitting element may be adjusted for reducing flicker in the display panel.

The present application discloses a driving circuit for display panel, which drives a plurality of pixel structures of a display panel. Each of the pixel structures includes a light-emitting element, which is coupled between a first voltage and a second voltage. The driving circuit comprises a power supply circuit, which is coupled to the pixel structures and provides the first voltage and the second voltage. The power supply circuit adjusts the first voltage or/and the second voltage for adjusting a voltage difference between the first voltage and the second voltage to adjust a current flowing through the light-emitting elements of the pixel structures for reducing the flicker in the display panel.

### BRIEF DESCRIPTION OF THE DRAWINGS

FIG. 1 shows a schematic diagram of the driving circuit driving the display panel according to an embodiment of the present application;

FIG. 2 shows a schematic diagram of a pixel structure of the display panel according to the present application;

FIG. 3 shows a schematic diagram of the brightness variation of the display panel when the first voltage and the second voltage provided to both terminals of the light-emitting elements are not adjusted by the driving circuit according to the present application;

FIG. 4 shows a schematic diagram of the brightness variation of the display panel with respect to a voltage difference between the first voltage and the second voltage when the first voltage and the second voltage provided to both terminals of the light-emitting elements are not adjusted by the driving circuit according to the present application;

FIG. 5 shows a schematic diagram of the brightness variation of the display panel with respect to a voltage difference between the first voltage and the second voltage when the first voltage and the second voltage provided to both terminals of the light-emitting elements are adjusted by the driving circuit according to an embodiment of the present application;

FIG. 6 shows a schematic diagram of the brightness variation of the display panel with respect to a voltage difference between the first voltage and the second voltage when the first voltage and the second voltage provided to both terminals of the light-emitting elements are adjusted by the driving circuit according to another embodiment of the present application; and

FIG. 7 shows a schematic diagram of the driving circuit driving the display panel according to another embodiment of the present application.

### DETAILED DESCRIPTION

In the specifications and the claims, certain words are used for representing specific elements. A person having ordinary skill in the art should know that hardware manufacturers may use different nouns to call the same element. In the specifications and claims, the differences in names are not used for distinguishing elements. Instead, the differences in functions are the guidelines for distinguishing. In the whole specifications and claims, the word “comprising” is an open language and should be explained as “comprising but not limited to”. Besides, the word “couple” includes any direct and indirect electrical connection. Thereby, if the description is that a first device is coupled to a second device, it means that the first device is connected electrically to the second device directly, or the first device is connected electrically to the second device via other device or connecting means indirectly.

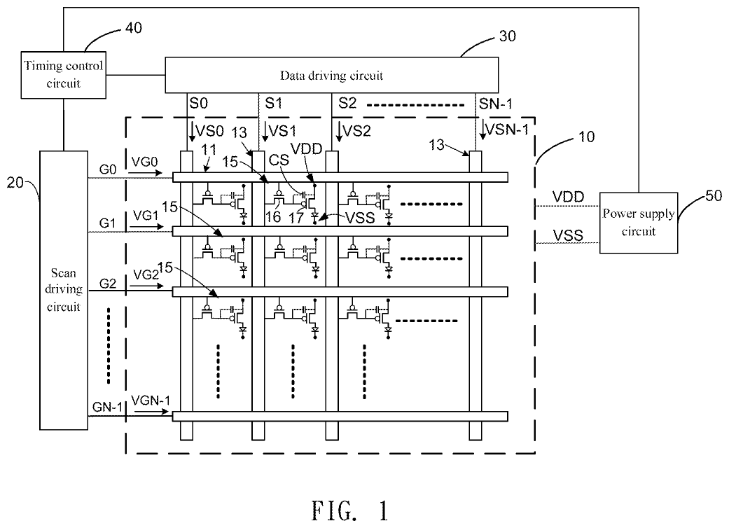

Please refer to FIG. 1, which shows a schematic diagram of the driving circuit driving the display panel according to an embodiment of the present application. As shown in the figure, the driving circuit according to the present application is applied for driving a display panel 10. The driving circuit comprises a scan driving circuit 20, a data driving circuit 30, a timing control circuit 40, and a power supply circuit 50. The display panel 10 includes a plurality of scan lines 11 (G0˜GN-1), a plurality of data lines (S0˜SN-1), and a plurality of pixel structures 15. The scan lines 11 are interlaced with the data lines 13. The pixel structures 15 are located at the intersections and each pixel structure 15 is coupled to a scan line 11 and a data line 13.

The scan driving circuit 20 is coupled to the scan lines 11 and generates a plurality of scan signals VG0˜VGN-1 to the scan lines 11. The scan lines 11 transmit the scan signals VG0˜VGN-1 to the pixel structures 15 on each row, respectively, for scanning the pixel structures 15 on each row. The data driving circuit 30 is coupled to the data lines 13 and generates a plurality of data signals VS0˜VSN-1 to the data lines 13. The data lines 13 transmit the data signals VS0˜VSN-1 to the pixel structures 15 on each column, respectively, for driving the pixel structures 15 to display image. The timing control circuit 40 is coupled to the scan driving circuit 20 and the data driving circuit 30 for controlling the operational timing of the scan driving circuit 20 and the data driving circuit 30. The power supply circuit 50 is coupled to the pixel structures 15 and provides a first voltage VDD and a second voltage VSS to the pixel structures 15. According to an embodiment of the present application, the voltage level of the first voltage VDD is greater than the voltage level of the second voltage VSS.

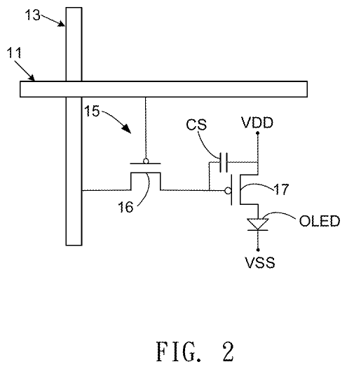

Please refer to FIG. 2, which shows a schematic diagram of a pixel structure of the display panel according to the present application. According to the embodiment as shown in FIG. 1, the display panel 10 is an active-matrix organic light-emitting diode (AMOLED) display panel, but the present application is not limited to this embodiment. FIG. 2 shows the pixel structure 15 of the display panel 10 according to the embodiment as shown in FIG. 1. As shown in the figure, each pixel structure 15 may include a transistor 16, a transistor 17, a storage capacitor CS, and a light-emitting element OLED. The gate and the source of the transistor 16 are coupled to the scan line 11 and the data line 13, respectively. The drain of the transistor 16 is coupled to the gate of the transistor 17. The source and the drain of the transistor 17 are coupled to the first voltage VDD and the anode of the light-emitting element OLED, respectively. The cathode of the light-emitting element OLED is coupled to the second voltage VSS. In other words, the light-emitting element OLED is coupled between the first voltage VDD and the second voltage VSS. A current flows from the first voltage VDD to the second voltage VSS through the transistor 17 and the light-emitting element OLED for driving the light-emitting element OLED to generate light. The storage capacitor CS is coupled between the gate and the source of the transistor 17. According to an embodiment of the present application, the transistors 16, 17 may be thin-film transistors (TFT).

The scan signal of the scan line 11 is transmitted to the gate of the transistor 16 for turning on or off the transistor 16. When the scan signal scans the transistor 16 and turns on the transistor 16, the data signal charges the storage capacitor CS for controlling the turn-on level of the transistor 17, namely, controlling the strength of the current flowing through the transistor 17. If the turn-on level of the transistor 17 is higher, the strength of the current flowing through the transistor 17 will be larger. That is, the strength of the current flowing through the light-emitting element OLED is large. Then the intensity of the light emitted from the light-emitting element OLED will be larger since the strength of the current flowing through the light-emitting element OLED is larger. Accordingly, the data signal is used for determining the brightness of the pixel structure 15.

When the scan driving circuit 20 scans the pixel structures 15 and the data driving circuit 30 generates the data signal to charge the storage capacitors CS as well as the transistor 17 is turned on, the current will flow through the light-emitting elements OLED for driving the light-emitting elements OLED to generate light and driving the pixel structures 15 to display image. Afterwards, the scan driving circuit 20 stops scanning the pixel structures 15 and maintains the displayed image until the driving circuit drives the display panel 10 to refresh the frame. Then, the scan driving circuit 20 re-scans the pixel structures 15 and the data driving circuit 30 generates the next data signal for charging the storage capacitors CS, again, and the pixel structures 15 are driven to display image. However, the storage capacitors CS have leakage current, which will influence the turn-on level of the transistors 17 and influence the strength of the current driving the light-emitting elements OLED. Consequently, the intensity of the light generated by the light-emitting elements OLED will become weak with time, leading to flicker phenomenon. In other words, if the frame rate of the display panel 10 is lower, the display panel 10 will maintains an image for a longer time as well as the storage capacitors CS will have current leakage for the longer time. Thereby, the flicker phenomenon will be more obvious.

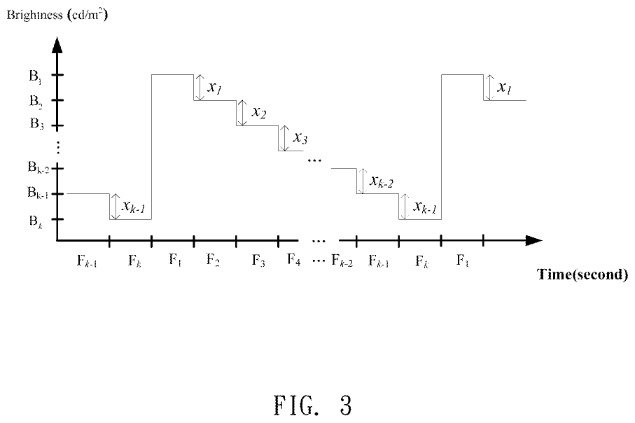

Please refer to FIG. 3, which shows a schematic diagram of the brightness variation of the display panel when the first voltage and the second voltage provided to both terminals of the light-emitting elements are not adjusted by the driving circuit according to the present application. When the first voltage VDD and the second voltage VSS are maintained constant and the frame rate of the display panel 10 is adjusted from n Hz to m Hz, where n is K times m and n, m, K are positive, the brightness of the display panel 10 will be decreased with time. The adjustment of the frame rate from n Hz to m Hz as described above means that, the frame is refreshed K times with n-Hz frame rate and only refreshed once with m-Hz frame rate, differing by K-1 frames. As shown in FIG. 3, when the first voltage VDD and the second voltage VSS are maintained constant, namely, the voltage difference V_{DS} between the first voltage VDD and the second voltage VSS is maintained constant, and under the frame rate of the display panel 10 is m Hz, the time of the display panel 10 to maintain image before frame refreshing is longer. That is, the time of current leakage in the storage capacitors CS without recharging becomes longer and the strength of the current flowing through the light-emitting elements OLED become smaller. Consequently, the brightness of the display panel 10 becomes weaker.

As shown in FIG. 3, F₁, F₂, F₃, F₄, F_{K-2}, F_{K-1}, F_{K} refer to the first, second, third, fourth, (K-2)-th, (K-1)-th, and K-th frame period at n-Hz frame rate. B₁˜B_{K} refer to the average brightness corresponding to the frame period F₁˜F_{K} at m-Hz frame rate of the display panel 10. X₁ is the difference between the brightness B₂ and the brightness B₁; X₂ is the difference between the brightness B₃ and the brightness B₂; X₃ is the difference between the brightness B₄ and the brightness B₃; X_{K-2} is the difference between the brightness B_{K-1} and the brightness B_{K-2}; and X_{K-1} is the difference between the brightness B_{K} and the brightness B_{K-1}. According to FIG. 3, at m-Hz frame rate, the display panel 10 displays the new image at each first frame period F₁. In other words, at the first frame period F₁, the data driving circuit 30 generates a new data signal and charges the storage capacitors CS for displaying a new image. Thereby, the brightness of the display panel 10 is strongest at the first frame period F₁. Afterwards, while maintaining the image until the K-th frame period F_{K}, the brightness of the display panel 10 becomes weaker with time and thus leading to the flicker phenomenon and affecting the display quality. The period between the above data driving circuit 30 starting to transmit the data signals to the pixel structures 15 and the data driving circuit 30 restarting to transmit the next data signals to the pixel structures 15 is a frame period, namely, the frame period is the period between two first frame periods F₁ as shown in FIG. 3.

Please refer again to FIG. 1 and FIG. 2. After the scan driving circuit 20 scans the pixel structures 15 and the data driving circuit 30 transmits the data signals to the pixel structures 15, and when the scan driving circuit 20 does not re-scan the pixel structures 15 and the data driving circuit 30 does not transmit the next data signals to the pixel structures 15, the power supply circuit 50 may adjust the voltage level of the first voltage VDD or/and the voltage level of the second voltage VSS for adjusting the voltage difference V_{DS} between the first voltage VDD and the second voltage VSS. When the voltage difference V_{DS} is larger, the current flowing through the transistor 17 is larger, namely, the current flowing through the light-emitting element OLED is larger as well. Thereby, the brightness of the light-emitting element OLED may be increased. According to an embodiment of the present application, the period between after the data driving circuit 30 transmits the data signals to the pixel structures 15 and before the data driving circuit 30 transmits the next data signals to the pixel structures 15, the power supply circuit 50 may adjust the voltage difference V_{DS} between the first voltage VDD and the second voltage VSS for multiple times. Then, the voltage difference V_{DS} is increased with time for adjusting the current driving the light-emitting elements OLED adaptively and hence compensating the influence of the leakage current of the storage capacitors CS on the current driving the light-emitting elements OLED. The timing control circuit 40 is coupled to the power supply circuit 50 and controls the time when the power supply circuit 50 adjusts the voltage difference V_{DS} between the first voltage VDD and the second voltage VSS.

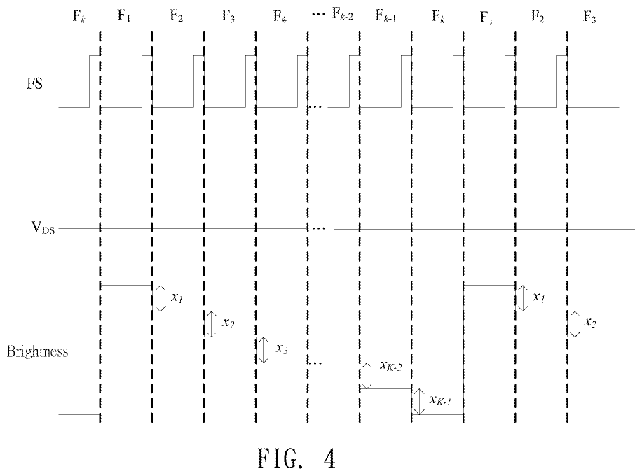

Please refer to FIG. 4, which shows a schematic diagram of the brightness variation of the display panel with respect to the voltage difference V_{DS} between the first voltage VDD and the second voltage VSS according to the embodiment as shown in FIG. 3. As shown in the figure, when the first voltage VDD and the second voltage VSS are maintained constant, namely, the voltage difference V_{DS} between the first voltage VDD and the second voltage VSS is maintained constant, under the frame rate of the display panel 10 is m Hz, the time of the display panel 10 maintaining the image without refresh is longer. Thereby, the brightness of the display panel 10 becomes weaker. The frame synchronization signal FS as shown in FIG. 4 is generated by the timing control circuit 40 and used for indicating the start time of the frame period.

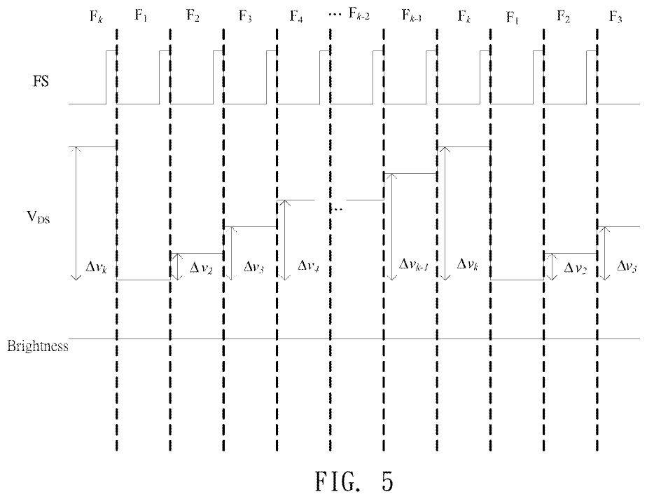

Please refer to FIG. 5, which shows a schematic diagram of the brightness variation of the display panel with respect to the voltage difference between the first voltage and the second voltage when the first voltage and the second voltage provided to both terminals of the light-emitting elements are adjusted by the driving circuit according to an embodiment of the present application. After the scan driving circuit 20 scans the pixel structures 15 and the data driving circuit 30 transmits the data signals to the pixel structures 15, and when the scan driving circuit 20 does not re-scan the pixel structures 15 and the data driving circuit 30 does not transmit the next data signals to the pixel structures 15, the power supply circuit 50 adjusts the voltage level of the first voltage VDD or/and the voltage level of the second voltage VSS in each frame period F₂˜F_{K} for adjusting the voltage difference V_{DS} between the first voltage VDD and the second voltage VSS and the voltage difference V_{DS} will be increased with time. Thereby, the brightness of the display panel 10 may be maintained close to constant and flicker will be reduced. The power supply circuit 50 adjusts the voltage level of the first voltage VDD or/and the voltage level of the second voltage VSS according to the frame synchronization signal FS. According to an embodiment of the present application, the power supply circuit 50 may count the frame synchronization signal FS. The counting is reset while counting to the K-th frame synchronization signal FS. Thereby, the power supply circuit 50 may adjust the voltage difference V_{DS} according to the frame synchronization signal FS. According to an embodiment of the present application, the adjusting value ΔV of the voltage difference V_{DS} may expressed as follows:

$$Δ {V}_{j} = {β}_{j} {\sum }_{i = 1}^{j - 1} {X}_{i} , j = 2 , 3 , 4 . . . , K$$

where βⱼ is a coefficient. According to an embodiment of the present application, βⱼ may be smaller than 1. Nonetheless, βⱼ may be set according to design requirements and the present application is not limited to values of βⱼ being smaller than 1.

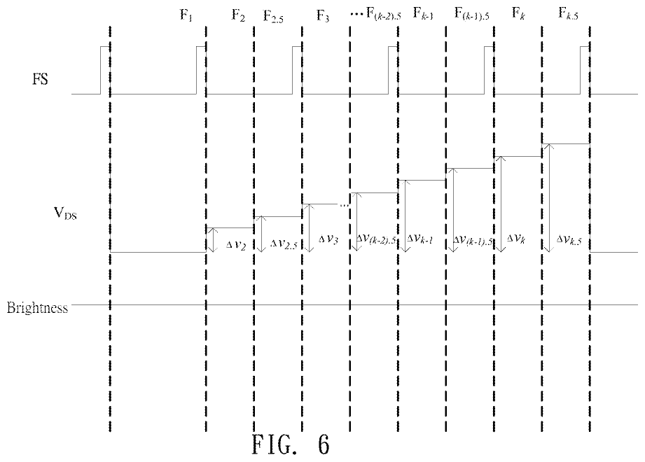

Please refer to FIG. 6, which shows a schematic diagram of the brightness variation of the display panel with respect to the voltage difference between the first voltage and the second voltage when the first voltage and the second voltage provided to both terminals of the light-emitting elements are adjusted by the driving circuit according to another embodiment of the present application. According to an embodiment of the present application, the power supply circuit 50 adjusts twice the voltage level of the first voltage VDD or/and the voltage level of the second voltage VSS in each frame period F₂˜F_{K} for adjusting twice the voltage difference V_{DS} between the first voltage VDD and the second voltage VSS. In other words, for every half frame period, the power supply circuit 50 adjusts the voltage difference V_{DS} once. Thereby, the brightness of the display panel 10 may be further maintained close to constant. According to the above description, the power supply circuit 50 adjusts the voltage difference V_{DS} for a predetermined period. The predetermined period may be determined according to requirements. The predetermined period may be half-frame period, one-frame period, or two-frame periods.

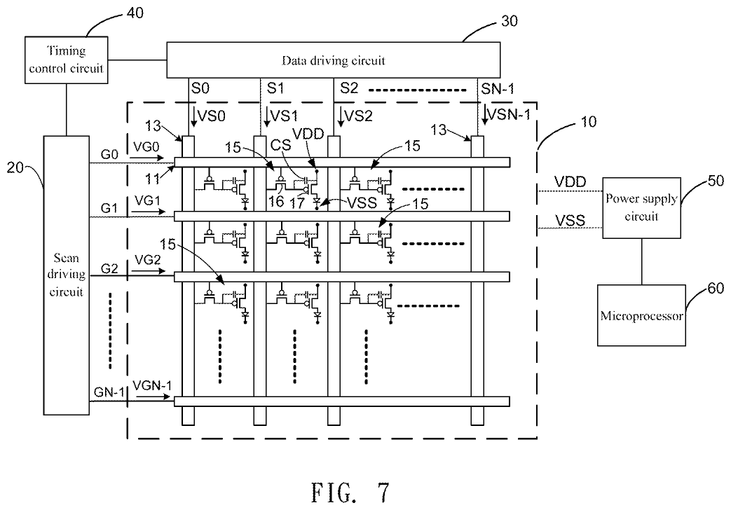

FIG. 7 shows a schematic diagram of the driving circuit driving the display panel according to another embodiment of the present application. As shown in the figure, the power supply circuit 50 may be further coupled to a microprocessor 60, which controls the time for the power supply circuit 50 to adjust the voltage difference V_{DS}. The microprocessor 60 may be further coupled to the timing control circuit 40 for controlling the power supply circuit 50 according to the frame synchronization signal FS generated by the timing control circuit 40. According to an embodiment of the present application, the microprocessor 60 may be a processor of an electronic device.

To sum up, the driving circuit according to the present application may provide the first voltage and the second voltage to the light-emitting elements of the pixel structures and adjust the first voltage or/and the second voltage for adjusting their voltage difference and hence the current driving the light-emitting elements is adjusted. Thereby, the flicker phenomenon in the display panel may be reduced.

Those skilled in the art will readily observe that numerous modifications and alterations of the circuit and structure may be made while retaining the teachings of the invention. Accordingly, the above disclosure should be construed as limited only by the metes and bounds of the appended claims.

1. A driving circuit for display panel, driving a plurality of pixel structures of a display panel, each of said pixel structures including a light-emitting element coupled between a first voltage and a second voltage, said driving circuit comprising:
a power supply circuit, coupled to said pixel structures, providing said first voltage and said second voltage, and adjusting said first voltage or/and said second voltage to adjust a voltage difference between said first voltage and said second voltage.

2. The driving circuit of claim 1, further comprising:
a scan driving circuit, coupled to a plurality of scan lines of said display panel, and scanning said pixel structures; and
a data driving circuit, coupled to a plurality of data lines of said display panel, generating a plurality of data signals, and transmitting said data signals to said pixel structures via said data lines to drive said pixel structures.

3. The driving circuit of claim 2, wherein after said data driving circuit transmits said data signals to said pixel structures, said power supply circuit adjusts said voltage difference between said first voltage and said second voltage.

4. The driving circuit of claim 3, wherein after said data driving circuit transmits said data signals to said pixel structures and before said data driving circuit transmits next plurality of data signals to said pixel structures, said power supply circuit adjusts said voltage difference between said first voltage and said second voltage for at least one time.

5. The driving circuit of claim 4, wherein said power supply circuit adjusts said voltage difference between said first voltage and said second voltage for multiple times, and said voltage difference increases with time.

6. The driving circuit of claim 4, wherein in a period between said data driving circuit starting to transmit said data signals to said pixel structures and said data driving circuit starting to transmit said next data signals to said pixel structures, said power supply circuit adjusts said voltage difference between said first voltage and said second voltage for every predetermined period.

7. The driving circuit of claim 1, further comprising a timing control circuit, coupled to said power supply circuit, said timing control circuit controlling the timing of said power supply circuit adjusting said voltage difference between said first voltage and said second voltage.

8. The driving circuit of claim 1, wherein said pixel structure further includes a transistor coupled between one terminal of said light-emitting element and said first voltage; and the other terminal of said light-emitting element is coupled to said second voltage.
